(19) United States
(12) Patent Application Publication
(10) Pub. No.: US 2014/0049245 A1
(43) Pub. Date: Feb. 20, 2014

(54) REFERENCE VOLTAGE GENERATION CIRCUIT OF SEMICONDUCTOR DEVICE

(71) Applicant: SK HYNIX INC., Icheon-si (KR)

(72) Inventors: Young Ran KIM, Icheon-si (KR); Jae Boum PARK, Icheon-si (KR); Kyoung Youn LEE, Icheon-si (KR)

(73) Assignee: SK HYNIX INC., Icheon-si (KR)

(21) Appl. No.: 13/724,355

(22) Filed: Dec. 21, 2012

(30) Foreign Application Priority Data
Aug. 17, 2012 (KR) 10-2012-0090135

(51) Int. Cl. G05F 1/46

(52) U.S. Cl. CPC G05F 1/468
USPC 323/314

(57) ABSTRACT

A reference voltage generation circuit includes: a reference voltage generation unit configured to generate a plurality of reference voltages having mutually different temperature characteristics, a switching unit configured to select and output one of the plurality of reference voltages in response to a control signal, a temperature detection unit configured to detect temperature change and to output a temperature detection signal, and a control unit configured to generate the control signal in response to the temperature detection to signal.

### CROSS-REFERENCES TO RELATED APPLICATION

The present application claims priority under 35 U.S.C. §119(a) to Korean application number 10-2012-0090135, filed on Aug. 17, 2012, in the Korean Intellectual Property Office, which is incorporated herein by reference in its entirety.

### BACKGROUND

1. Technical Field

The present invention relates generally to a semiconductor device, and more particularly, to a reference voltage generation circuit.

2. Related Art

As the name implies, a semiconductor device such as a semiconductor memory uses a reference voltage as a reference for generating various operating voltages used therein, and includes a reference voltage generation circuit for generating the reference voltage within the semiconductor memory.

As illustrated in FIG. 1, a conventional reference voltage generation circuit 1 of a semiconductor device includes a reference voltage generation unit 2 and a trimming unit 3.

The reference voltage generation unit 2 generates a reference voltage VREF.

The trimming unit 3 performs a trimming operation on the reference voltage VREF to generate a plurality of reference voltages VREF0 to VREFn.

The trimming unit 3 can generate the plurality of reference voltages VREF0 to VREFn by dividing the reference voltage VREF by mutually different division ratios through division resistors.

The plurality of reference voltages VREF0 to VREFn are used as references for generating various operating voltages within the semiconductor device.

The reference voltage VREF may be generated to maintain a constant voltage level regardless of temperature change.

Therefore, the plurality of reference voltages VREF0 to VREFn may also maintain constant voltage levels regardless of temperature change.

However, various components of a semiconductor memory may require different voltage levels for proper operation when temperature changes.

For example, as the structure of a cell includes a transistor and a capacitor, the transistor, especially when the transistor is an NMOS transistor, requires an increased threshold voltage when temperature decreases.

When the threshold voltage of a transistor increases according to decrease of temperature, as described above, it is necessary to increase the gate voltage of the transistor.

However, when a voltage which is constantly maintained regardless of temperature change is used, as described above, the operating characteristics of the transistor may deteriorate.

Similarly, in the case of a delay circuit, the aforementioned characteristic change according to temperature change may occur therein, so that the operating characteristics thereof deteriorate when a voltage constantly maintained regardless of temperature change is used.

### SUMMARY

A reference voltage generation circuit of a semiconductor device capable of providing reference voltages having various temperature characteristics is described herein.

A reference voltage generation circuit of a semiconductor device capable of selectively providing reference voltages having various temperature characteristics according to the temperature characteristics of corresponding components is described herein.

In an embodiment, a reference voltage generation circuit includes: a reference voltage generation unit configured to generate a plurality of reference voltages having mutually different temperature characteristics, a switching unit configured to select and output one of the plurality of reference voltages in response to a control signal, a temperature detection unit configured to detect temperature change and to output a temperature detection signal, and a control unit configured to generate the control signal in response to the temperature detection signal.

In another embodiment, a reference voltage generation circuit includes: a reference voltage generation unit configured to generate a plurality of reference voltages having mutually different temperature characteristics, a plurality of switching units configured to individually select and output one of the plurality of reference voltages in response to a plurality of control signals, a temperature detection unit configured to detect temperature change and to output a temperature detection signal, and a control unit configured to generate, in response to the temperature detection signal, the plurality of control signals to allow the plurality of switching units to select mutually different reference voltages from among the plurality of reference voltages.

### BRIEF DESCRIPTION OF THE DRAWINGS

Features, aspects, and embodiments are described in conjunction with the attached drawings, in which:

FIG. 1 is a block diagram illustrating the configuration of a conventional reference voltage generation circuit of a semiconductor device;

FIG. 2 is a block diagram illustrating the configuration of a reference voltage generation circuit of a semiconductor device according to an embodiment; and

FIG. 3 is a block diagram illustrating the configuration of a reference voltage generation circuit of a semiconductor device according to another embodiment.

### DETAILED DESCRIPTION

Hereinafter, a reference voltage generation circuit of a semiconductor device according to the present invention will be described below with reference to the accompanying drawings through various embodiments.

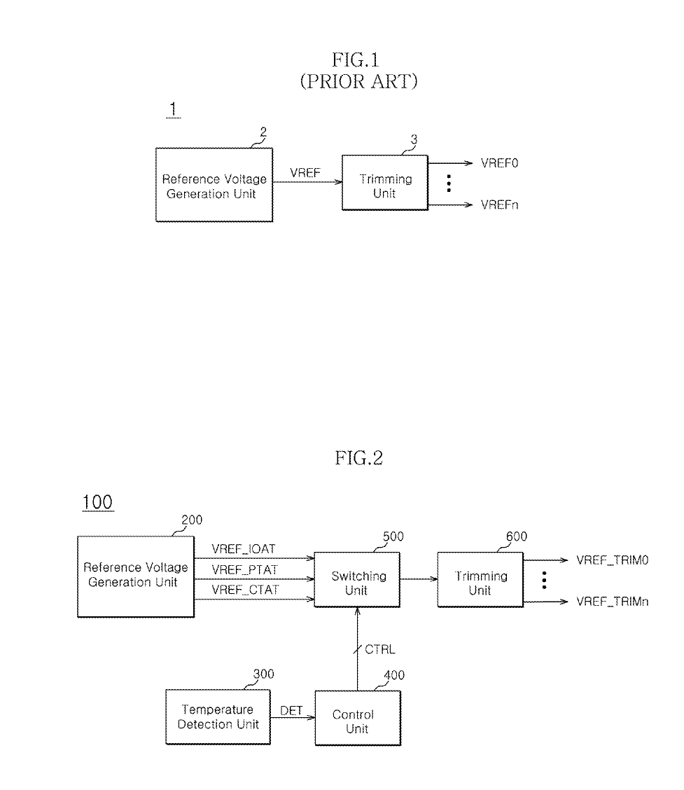

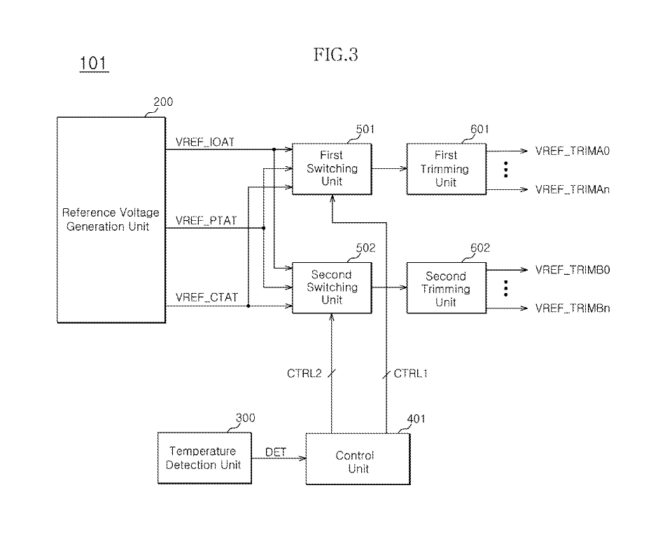

FIG. 2 is a block diagram illustrating the configuration of a reference voltage generation circuit 100 of a semiconductor device according to an embodiment.

As illustrated in FIG. 2, the reference voltage generation circuit 100 of a semiconductor device according to an embodiment includes a reference voltage generation unit 200, a temperature detection unit 300, a control unit 400, a switching unit 500, and a trimming unit 600.

The reference voltage generation unit 200 is configured to generate first, second, and third reference voltages VREF_IOAT, VREF_PTAT, and VREF_CTAT, respectively, having mutually different temperature characteristics.

The first reference voltage VREF_IOAT is an independent-of-absolute-temperature type reference voltage having a characteristic of maintaining a constant voltage level regardless of temperature change.

The second reference voltage VREF_PTAT is a proportion-to-absolute-temperature type reference voltage having a characteristic of direct proportionality, such as providing an increased voltage level in correlation with an increased temperature.

The third reference voltage VREF_CTAT is a complementary-to-absolute-temperature type reference voltage having a characteristic of indirect proportionality, such as providing a decreased voltage level in correlation with an increased temperature.

The reference voltage generation unit 200 can generate one reference voltage, e.g. the first reference voltage VREF_IOAT, among the first, second, and third reference voltages VREF_IOAT, VREF_PTAT, and VREF_CTAT, and can generate the second reference voltage VREF_PTAT and third reference voltage VREF_CTAT by applying the first reference voltage VREF_IOAT to a variable resistor configured to increase resistance as temperature changes, and to a variable resistor configured to decrease resistance as temperature changes.

The temperature detection unit 300 is configured to detect various temperature changes, e.g. an internal temperature change of a semiconductor device or a circumference temperature change, and to output a temperature detection signal DET.

The temperature detection unit 300 can output the temperature detection signal DET in analog or digital form.

For convenience of description, it is assumed that the temperature detection unit 300 is configured to generate the temperature detection signal DET in the form of a digital code.

The control unit 400 is configured to generate a control signal CTRL in response to the temperature detection signal DET.

The control unit 400 is configured in the following ways: to compare a temperature detection signal DET, i.e. a digital code, with an internal setting code, to determine whether the current temperature is higher, lower, or is within the maximum value of a set temperature range, the minimum value of a set temperature range, or a set temperature range, respectively,, and to generate a control signal CTRL to allow one of the first, second, and third reference voltages VREF_IOAT, VREF_PTAT, and VREF_CTAT, corresponding to a result of the determination, to be selected.

For example, when the current temperature is within the set temperature range, the control unit 400 can generate a control signal CTRL to select the first reference voltage VREF_IOAT.

When the current temperature is lower than the minimum value of the set temperature range, the control unit 400 can generate a control signal CTRL to select the second reference voltage VREF_PTAT.

When the current temperature is higher than the maximum value of the set temperature range, the control unit 400 can generate a control signal CTRL to select the third reference voltage VREF_CTAT.

The above description is only an example of how to select reference voltages according to temperature conditions. Ways to select one of the first, second, and third reference voltages VREF_IOAT, VREF_PTAT, and VREF_CTAT according to temperature conditions can be changed depending on logic circuit programming of the control unit 400.

Since the control signal CTRL is intended to select one of the first, second, and third reference voltages VREF_IOAT, VREF_PTAT, and VREF_CTAT as described above, the control signal CTRL can be configured with two or more bits.

When the control signal CTRL is in analog form, one signal line can be used for the control signal.

The switching unit 500 is configured to select and output one of the first, second, and third reference voltages VREF_IOAT, VREF_PTAT, and VREF_CTAT in response to a control signal CTRL.

The switching unit 500 can be configured with a multiplexer.

The trimming unit 600 is configured to divide an output of the switching unit 500 by mutually different division ratios through division resistors, and to generate a plurality of reference voltages VREF_TRIM0 to VREF_TRIMn.

A semiconductor device may be required to use reference voltages having mutually different temperature characteristics.

For example, circuit block A (not shown) may need the first reference voltage VREF_IOAT, and circuit block B (not shown) may need the second reference voltage VREF_PTAT or third reference voltage VREF_CTAT according to particular temperature conditions.

Therefore, another embodiment is directed to a configuration which enables reference voltages having mutually different temperature characteristics depending on temperature conditions to be provided to mutually different circuit constructions.

FIG. 3 is a block diagram illustrating the configuration of a reference voltage generation circuit 101 of a semiconductor device according to another embodiment.

As illustrated in FIG. 3, the reference voltage generation circuit 101 of a semiconductor device according to an embodiment includes a reference voltage generation unit 200, a temperature detection unit 300, a control unit 401, a first switching unit 501, a second switching unit 502, a first trimming unit 601 and a second trimming unit 602.

The reference voltage generation unit 200 is configured to generate a plurality of reference voltages VREF_IOAT, VREF_PTAT, and VREF_CTAT having mutually different temperature characteristics.

The first reference voltage VREF_IOAT is an independent-of-absolute-temperature type reference voltage having a characteristic of maintaining a constant voltage level regardless of temperature change.

The second reference voltage VREF_PTAT is a proportion-to-absolute-temperature type reference voltage having a characteristic of direct proportionality, such as providing an increased voltage level in correlation with an increased temperature.

The third reference voltage VREF_CTAT is a complementary-to-absolute-temperature type reference voltage having a characteristic of indirect proportionality, such as providing a decreased voltage level in correlation with an increased temperature.

The reference voltage generation unit 200 can generate one reference voltage, e.g. the first reference voltage VREF_IOAT, among the first, second, and third reference voltages VREF_IOAT, VREF_PTAT, and VREF_CTAT, and can generate the second reference voltage VREF_PTAT and third reference voltage VREF_CTAT by applying the first reference voltage VREF_IOAT to a variable resistor configured to increase resistance as temperature changes, and to a variable resistor configured to decrease resistance as temperature changes.

The first switching unit 501 is configured to select and output one of the first, second, and third reference voltages VREF_IOAT, VREF_PTAT, and VREF_CTAT in response to a first control signal CTRL1.

The second switching unit 502 is configured to select and output one of the first, second, and third reference voltages VREF_IOAT, VREF_PTAT, and VREF_CTAT in response to a second control signal CTRL2.

Each of the first switching unit 501 and second switching unit 502 can be configured with a multiplexer.

The first trimming unit 601 is configured to divide an output of the first switching unit 501 by mutually different division ratios through division resistors, and to generate a plurality of reference voltages VREF_TRIMA0 to VREF_TRIMAn.

The second trimming unit 602 is configured to divide an output of the second switching unit 502 by mutually different division ratios through division resistors, and to generate a plurality of reference voltages VREF_TRIMB0 to VREF_TRIMBn.

The temperature detection unit 300 is configured to detect various temperature changes, e.g. an internal temperature change of a semiconductor device or a circumference temperature change, and to output a temperature detection signal DET.

The temperature detection unit 300 can output the temperature detection signal DET in analog or digital form.

For convenience of description, it is assumed that the temperature detection unit 300 is configured to generate the temperature detection signal DET in the form of a digital code.

The control unit 401 is configured to generate a first control signal CTRL1 and a second control signal CTRL2 in response to the temperature detection signal DET.

The control unit 401 is configured to generate the first control signal CTRL1 and the second control signal CTRL2 for enabling the first switching unit 501 and second switching unit 502 to select reference voltages having mutually different temperature characteristics in response to the temperature detection signal DET.

The control unit 401 can be configured in the following ways: to compare a temperature detection signal DET, i.e. a digital code, with an internal setting code, to determine whether the current temperature is higher, lower, or is within the maximum value of a set temperature range, the minimum value of a set temperature range, or a set temperature range, respectively, and to generate a first control signal CTRL1 and a second control signal CTRL2 to allow each of the control signals to select one of the first, second, and third reference voltages VREF_IOAT, VREF_PTAT, and VREF_CTAT, corresponding to a result of the determination.

For example, when the current temperature is lower than the minimum value of a set temperature range, the control unit 401 can generate the first control signal CTRL1 for allowing the first switching unit 501 to select the second reference voltage VREF_PTAT, while the control unit 401 generates the second control signal CTRL2 for allowing the second switching unit 502 to select the third reference voltage VREF_CTAT.

When the current temperature is higher than the maximum value of a set temperature range, the control unit 401 can generate the first control signal CTRL1 for allowing the first switching unit 501 to select the third reference voltage VREF_CTAT, while the control unit 401 generates the second control signal CTRL2 to allow the second switching unit 502 to select the second reference voltage VREF_PTAT.

The above description is only an example of how to select reference voltages according to temperature conditions. Ways to select one of the first, second, and third reference voltages VREF_IOAT, VREF_PTAT, and VREF_CTAT according to temperature conditions can be changed depending on logic circuit programming of the control unit 401.

Since each of the first control signal CTRL1 and second control signal CTRL2 is intended to select one of the first, second, and third reference voltages VREF_IOAT, VREF_PTAT, and VREF_CTAT as described above, each of the first control signal CTRL1 and second control signal CTRL2 can be configured with two or more bits.

When the first control signal CTRL1 and second control signal CTRL2 are in analog form, one signal line can be used for each of the control signals.

In addition, the control unit 401 can be configured in the following ways: to compare a temperature detection signal DET, i.e. a digital code, with a first internal setting code and to generate the first control signal CTRL1 according to a result of determining temperature change; and to compare the temperature detection signal DET with a second internal setting code and to generate the second control signal CTRL2 according to a result of determining temperature change.

More specifically, the control unit 401 can be configured: to compare a temperature detection signal DET, i.e. a digital code, with a first internal setting code, to determine whether the current temperature is higher, lower, or is within the maximum value of a set temperature range, the minimum value of a set temperature range, or a set temperature range, respectively, and to generate a first control signal CTRL1 to allow each switching unit to individually select one of the first, second, and third reference voltages VREF_IOAT, VREF_PTAT, and VREF_CTAT, corresponding to a result of the determination.

The control unit 401 can be configured: to compare a temperature detection signal DET, i.e. a digital code, with a second internal setting code; to determine whether the current temperature is higher, lower, or is within the maximum value of a set temperature range, the minimum value of a set temperature range, or a set temperature range, respectively, and to generate a second control signal CTRL2 to allow each switching unit to individually select one of the first, second, and third reference voltages VREF_IOAT, VREF_PTAT, and VREF_CTAT, corresponding to a result of the determination.

The first setting code and the second setting code are set to mutually different values so that temperature conditions for selecting the output of the first switching unit 501 and the output of the second switching unit 502 may be different from each other.

The above description is only an example of how to select reference voltages according to temperature conditions. Ways to select one of the first, second, and third reference voltages VREF_IOAT, VREF_PTAT, and VREF_CTAT according to temperature conditions may be changed depending on logic circuit programming of the control unit 401.

According to the embodiments of the present invention, the operating performances of semiconductor devices can be improved by appropriately coping with temperature change.

While certain embodiments have been described above, it will be understood to those skilled in the art that the embodiments described are by way of example only. Accordingly, the circuit described herein should not be limited based on the described embodiments. Rather, the circuit described herein should only be limited in light of the claims that follow when taken in conjunction with the above description and accompanying drawings.

What is claimed is:

1. A reference voltage generation circuit of a semiconductor device, comprising:
a reference voltage generation unit configured to generate a plurality of reference voltages having mutually different temperature characteristics;
a switching unit configured to select and output one of the plurality of reference voltages in response to a control signal;
a temperature detection unit configured to detect temperature change and to output a temperature detection signal; and
a control unit configured to generate the control signal in response to the temperature detection signal.

2. The circuit according to claim 1, wherein the plurality of reference voltages comprises:
a first reference voltage having a characteristic of maintaining a constant voltage level regardless of temperature change,
a second reference voltage having a characteristic of direct proportionality wherein an increased voltage level in correlation with an increased temperature is provided, and
a third reference voltage having a characteristic of indirect proportionality wherein a decreased voltage level in correlation with an increased temperature is provided.

3. The circuit according to claim 1, wherein the switching unit comprises a multiplexer.

4. The circuit according to claim 1, wherein the control unit is configured in the following ways: to determine temperature change by comparing the temperature detection signal with an internal setting value, and to generate the control signal to allow one of the plurality of reference voltages, corresponding to a result of the determination, to be selected.

5. The circuit according to claim 4, wherein the control unit is further configured to determine whether the current temperature is higher, lower, or is within the maximum value of a set temperature range, the minimum value of a set temperature range, or a set temperature range, respectively.

6. The circuit according to claim 1, further comprising a trimming unit configured to divide an output of the switching unit by mutually different division ratios through a division resistor, and to generate a plurality of voltages.

7. A reference voltage generation circuit of a semiconductor device, comprising:
a reference voltage generation unit configured to generate a plurality of reference voltages having mutually different temperature characteristics;
a plurality of switching units configured to individually select and output one of the plurality of reference voltages in response to a plurality of control signals;
a temperature detection unit configured to detect temperature change and to output a temperature detection signal; and
a control unit configured to generate, in response to the temperature detection signal, the plurality of control signals to allow the plurality of switching units to select mutually different reference voltages from among the plurality of reference voltages.

8. The circuit according to claim 7, wherein the plurality of reference voltages comprises:
a first reference voltage having a characteristic of maintaining a constant voltage level regardless of temperature change,
a second reference voltage having a characteristic of direct proportionality wherein an increased voltage level in correlation with an increased temperature is provided, and
a third reference voltage having a characteristic of indirect proportionality wherein a decreased voltage level in correlation with an increased temperature is provided.

9. The circuit according to claim 7, wherein the plurality of switching units are comprised of multiplexers.

10. The circuit according to claim 7, wherein the control unit is configured in the following ways: to compare the temperature detection signal with an internal setting value, and to generate the plurality of control signals to allow the plurality of switching units to select mutually different reference voltages from among the plurality of reference voltages, according to a result of determining temperature change.

11. The circuit according to claim 10, wherein the control unit is further configured to determine whether the current temperature is higher, lower, or is within the maximum value of a set temperature range, the minimum value of a set temperature range, or a set temperature range, respectively.

12. The circuit according to claim 7, wherein the circuit is configured to compare the temperature detection signal with a plurality of mutually different setting values, and generate the plurality of control signals according to a result of determining temperature change.

13. The circuit according to claim 7, further comprising a plurality of trimming units configured to divide outputs of the plurality of switching units by mutually different division ratios through respective division resistors, and to generate a plurality of voltages.
